(19) United States
(12) Patent Application Publication
(10) Pub. No.: US 2021/0406945 A1
(43) Pub. Date: Dec. 30, 2021

(54) COMPUTER-IMPLEMENTED METHODS AND SYSTEMS FOR DISTRIBUTING REWARD POINTS TO COMPUTER NETWORK USERS

(71) Applicant: AIM System Pte Ltd, Singapore (SG)

(72) Inventor: Wai Chong Eldee Tang, Singapore (SG)

(73) Assignee: AIM System Pte Ltd, Singapore (SG)

(21) Appl. No.: 17/173,167

(22) Filed: Feb. 10, 2021

(30) Foreign Application Priority Data
Jan. 10, 2020 (SG) 10202000279Q

(51) Int. Cl. G06Q 30/02

(52) U.S. Cl. CPC G06Q 30/0226; G06Q 30/0234; G06Q 30/0215

(57) ABSTRACT

A computer-implemented method of distributing reward points to computer network users in a transaction system, said users being arranged in a hierarchy, comprises: periodically performing a payout process for each user comprising: determining a direct reward points amount that is dependent on network activity that is directly attributable to the user; determining an indirect incentive amount that is at least partly dependent on network activity that is attributable to other users that are below said user in the hierarchy; and crediting a digital wallet of the user by the direct reward points amount and the indirect reward points amount; wherein said network activity comprises one or more electronic transactions conducted via the transaction system, and/or addition of one or more users to the transaction system.

### CROSS-REFERENCE TO RELATED APPLICATIONS

This application claims priority under 35 U.S.C. 119 to Singapore application no. 10202000279Q filed on 10 Jan. 2020, which is incorporated herein by reference in its entirety.

### BACKGROUND

The present invention relates, in general terms, to computer-implemented methods and systems for distributing reward points to computer network users.

E-commerce merchants are constantly seeking to find ways to encourage users to make purchase transactions with them. One way in which this is done is to implement loyalty and reward programs, in which points are awarded to users based on their purchases. However, such programs can sometimes be ineffective, in that users may not receive sufficient rewards to encourage them to continue to make purchases.

It would be desirable to overcome or alleviate the above-described problem, or at least to provide a useful alternative.

### SUMMARY

Disclosed herein is a computer-implemented method of distributing reward points to computer network users in a transaction system, said users being arranged in a referral hierarchy, the method comprising:
periodically performing a reward points distribution process for each user comprising:
determining a direct rewards amount that is dependent on network activity that is directly attributable to the user;
determining an indirect rewards amount that is at least partly dependent on network activity that is attributable to other users that are below the said user in the referral hierarchy; and
crediting the direct and indirect reward points to the rewards passport of the user;
wherein said network activity comprises one or more electronic transactions conducted via the transaction system, and/or addition of one or more users to the transaction system.

The direct and/or indirect reward points amount may be one or more of a rebate, or an increment to a loyalty points balance.

The indirect rewards amount may be capped according to a reward points balance of the user.

The method may comprise crediting an additional direct and/or indirect reward points amount to the digital wallet which dependable of the purchases transaction made by the users themselves or purchases by the other users that are fall under the referral hierarchy of the original users.

In certain embodiments, the crediting of the additional direct and/or indirect rewards amount occurs during the reward points distribution process.

Also disclosed herein is a system for distributing reward points to computer network users, comprising a transaction system having at least one processor and computer-readable storage having stored thereon instructions for causing the at least one processor to perform a method as disclosed herein.

Further disclosed herein is a system comprising:
a transaction system; and
at least one unattended commerce device in communication with the transaction system;
wherein the unattended commerce device is configured to receive, from a user and/or the transaction system, an authorisation token indicative of completion of payment for a product vendible by the unattended commerce device, and responsive thereto, to vend the product; and
wherein the transaction system is configured to:
   receive, from the unattended commerce device, transaction data comprising a transaction completion indicator; and
   update network activity data for the user based on the transaction data, the network activity data being based on an amount of the payment and/or a type of the product.

Also disclosed herein is a non-transitory computer-readable medium having stored thereon machine-readable instructions for causing at least one processor to perform the method as disclosed herein.

### BRIEF DESCRIPTION OF THE DRAWINGS

Embodiments of the present invention will now be described, by way of non-limiting example, with reference to the drawings in which:

FIG. 1 is a system architecture diagram of an exemplary networked system;

FIG. 2 is an exemplary network user graph;

FIG. 3 is a flow diagram of an example user sign-up process;

FIG. 4 is a flow diagram of an exemplary method of distributing reward points to users in a transaction system;

FIG. 5 is a flow diagram of a direct rewards process of the method of FIG. 4;

FIG. 6 is a flow diagram of an indirect (community-based) rewards process of the method of FIG. 4;

FIG. 7 is a schematic diagram of mobile devices transacting with an unattended commerce device;

FIG. 8 is a block diagram of an example system architecture of a transaction system;

FIG. 9 is a block diagram of an example system architecture of an unattended commerce device of the system of FIG. 1;

FIG. 10 is an example of a dashboard screen presented to a network user in the system of FIG. 1;

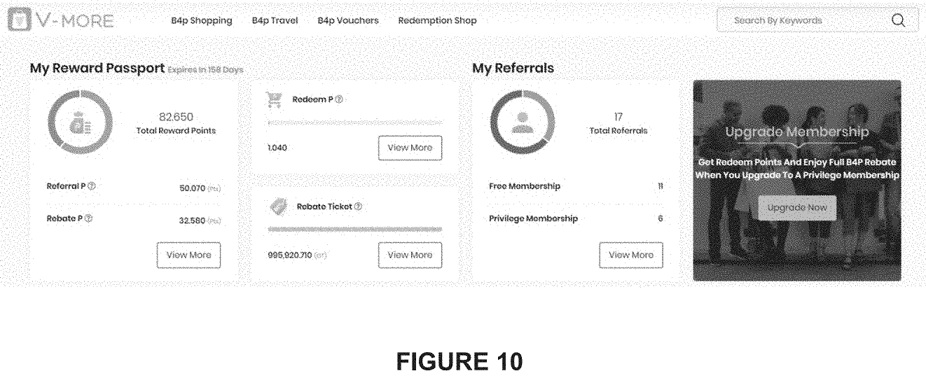

FIG. 11 is an example of a referral screen presented to a network user in the system of FIG. 1;

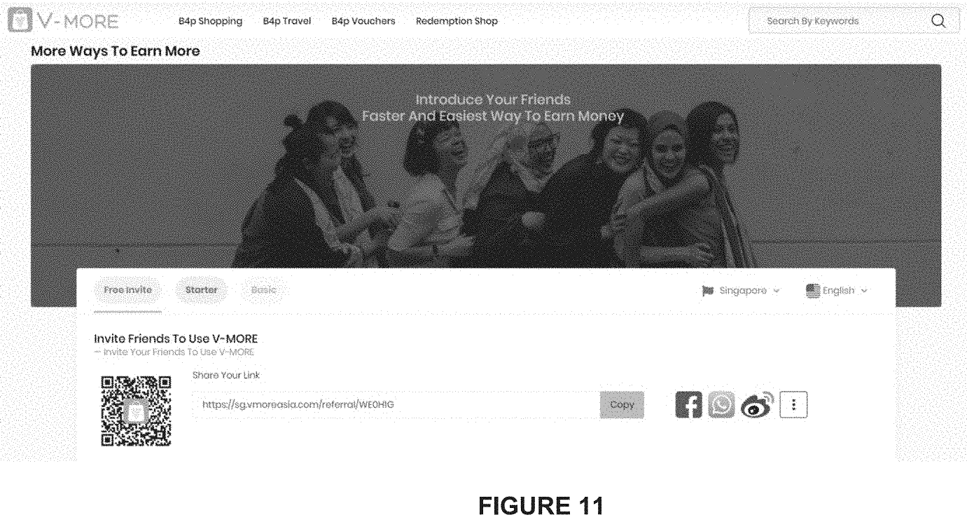

FIG. 12 is an example screen showing a network of users referred by a free user or subscriber; and

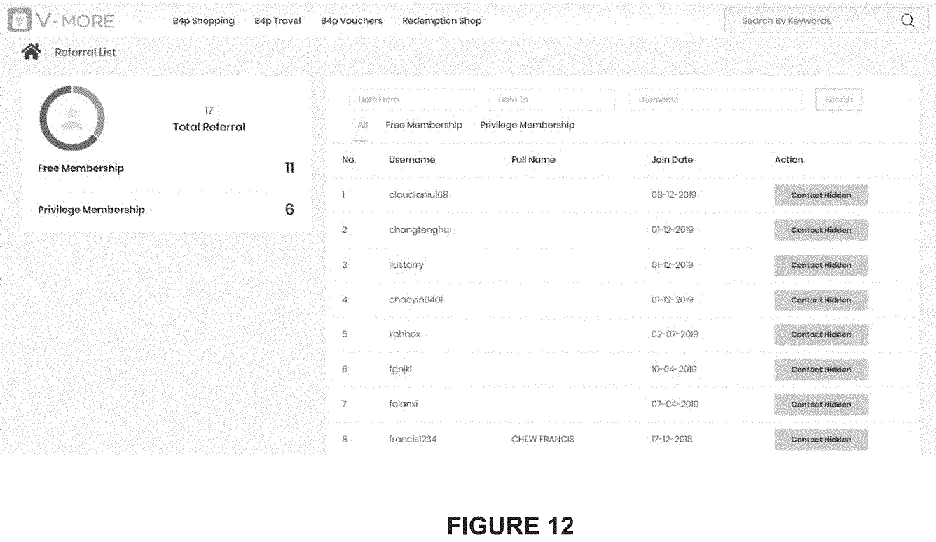

FIG. 13 is an example screen showing a user value top-up in the system of FIG. 1.

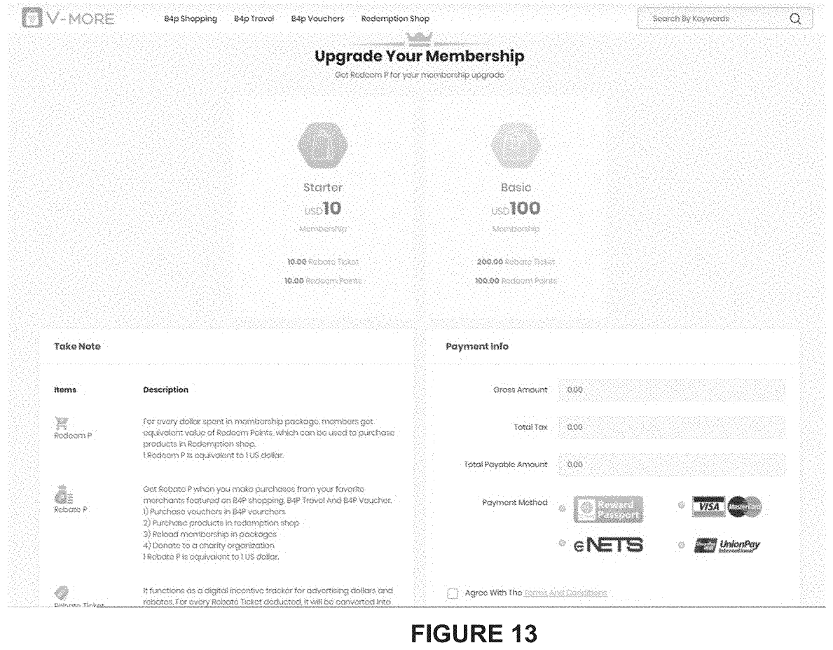

### DETAILED DESCRIPTION

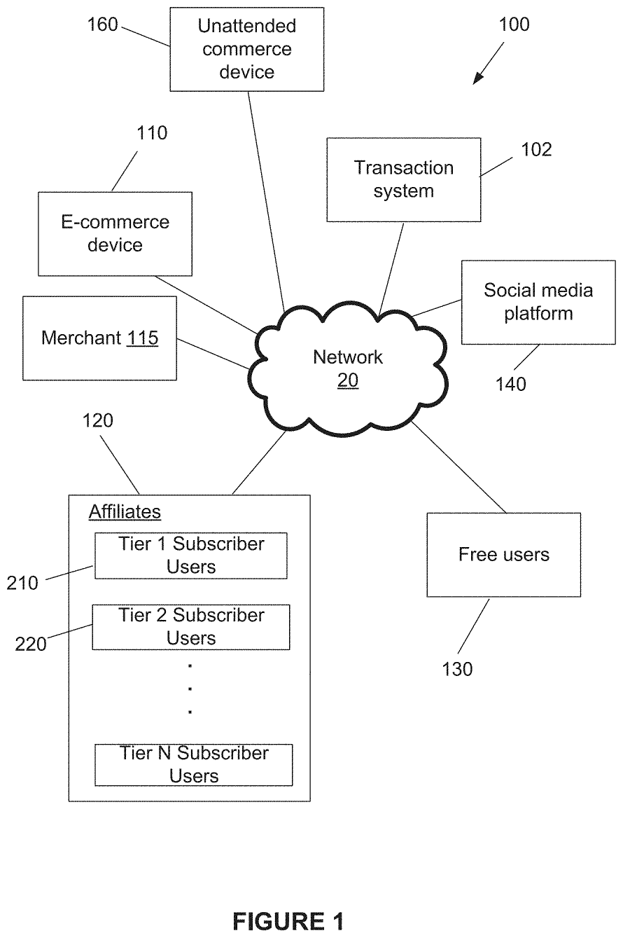

An exemplary networked system 100 is shown in FIG. 1. The system 100 comprises a transaction system 102 that comprises one or more e-commerce devices 110, a plurality of subscriber user devices 120, and a plurality of free user devices 130. Each user device is associated with a user who has an account managed by a transaction system 102. The devices 110, 120, 130 are in communication with the transaction system 102 via a network 20, such as the Internet.

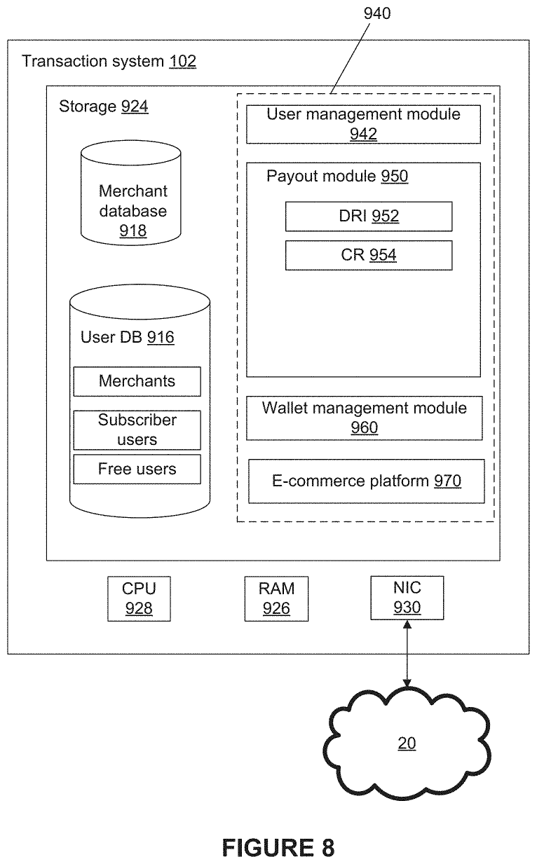

E-commerce device 110 maintains details of a plurality of subscription packages that are made available for sale via an e-commerce platform that is part of, or in communication with, the transaction server 102 (e.g., e-commerce platform 970 of FIG. 8).

Accordingly, users, such as subscriber users 120 and/or free users 130), may browse to a web page implemented by the e-commerce platform to select and pay for the subscription packages offered through the e-commerce platform.

The transaction system 102 may apply reward points to such purchases for registered users, such as a Direct reward or community reward. Reward Points may be redeemed for discount vouchers to be used for offline purchases of products, or may be used to make further online purchases at transaction system 102, for example under a restricted (redemption items) category only.

Some embodiments also comprise one or more (typically, many) unattended commerce devices 160, such as vending machines or other types of self-service kiosk. Unattended commerce devices 160 are registered with the transaction server 102. For example, each unattended commerce device 160 may have a device identifier associated with it and stored in user database 916 of the transaction server 102. As such, transactions that are made by users (such as subscriber users 120 or free users 130) at unattended commerce device 160 may be logged by transaction system 102, and used to credit user accounts in accordance with a rebate or use as making purchases in unattended commerce device 160.

Subscriber users 120 are computer network users who are registered with transaction system 102. The accounts of subscriber users 120 are linked to the e-commerce device 110 through transaction system 102, and purchases of subscription packages offered by e-commerce device 110 as listed at e-commerce platform 970 that are influenced directly or indirectly by subscriber users 120 can be tracked such that subscriber users 120 can be rewarded appropriately through the transaction system 102.

Subscriber users 120 of transaction system 102 may publish one or more online referral links from transaction system 102, for example to an online platform such as social media platforms 140 or a website. The published content may comprise a signing up platform for a new user to register as free user. Accordingly, transaction system 102 can monitor purchases of subscription packages that are directly linked to activity of subscriber users 120. Transaction system 102 may credit subscribers 120 for these sales, for example by incrementing a reward points balance in the digital wallet of a subscriber user 120, in a manner which will be described in more detail below.

In addition, subscriber users 120 and free users 130 may indirectly earn Reward Points by referring further subscribers or free users 130 to purchase Subscription Packages listed in the transaction system 102 by a signing up process with the necessary details in transaction system 102. Subscriber users 120 or free users 130 may also indirectly earn reward points through activity of referred users with which he or she is associated, for example in a “community reward” mechanism which is described in further detail below.

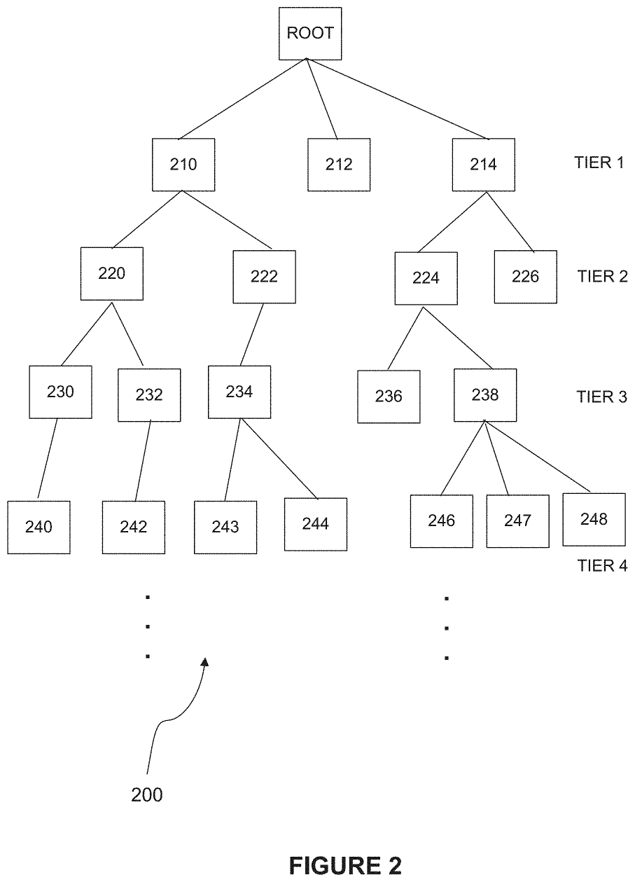

Turning to FIG. 2, an illustrative example of a user referral hierarchy in system 100 is shown. The user referral hierarchy may be represented as a graph or rooted tree. Subscriber users 210, 212 and 214 are first generation or “Tier 1” users at the first level of the tree. In the example shown in FIG. 2, Tier 1 subscriber user 210 has referred two further subscriber users (220 and 222) that are signed up with transaction system 102, and another Tier 1 subscriber user 214 has referred two further subscriber users (224 and 226) that have signed up with transaction system 102. The subscribers 220, 222, 224 and 226 are second generation or “Tier 2” subscribers. The Tier 2 subscribers may further refer subscriber users, and so on.

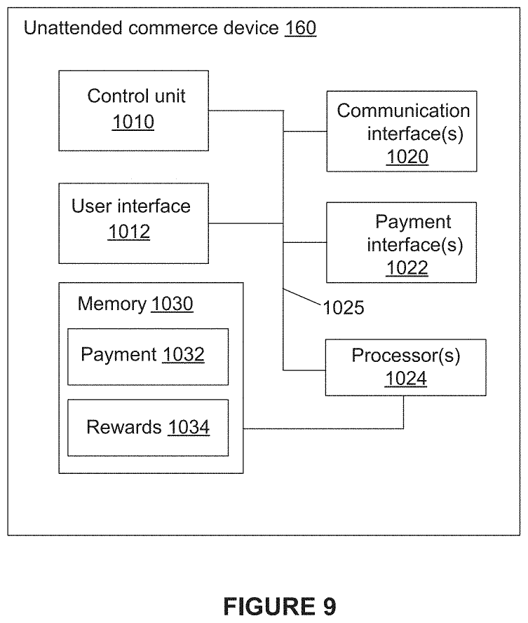

To register with transaction system 102, a user 210 may be presented, via a computing device, a sign-up web page via which they may choose a username and password, and enter information that is required for Know Your Customer (KYC) purposes. Information entered by the user may be stored in a user database 916 of the transaction system 102 (FIG. 9).

As mentioned above, system 102 may enable free users 130 to browse subscription packages that are listed in the transaction system 102.

Transaction system 102 may permit users to purchase a “subscription package” (which is entirely at the user's discretion, and not a requirement in the transaction system 102). Upon purchasing the package, transaction system 102 increments one or more balances in the user's digital wallet, referred to at various places hereinbelow as a Reward Passport. Packages may have different value, resulting in differing increments of the one or more Rewards Passport balances, and provide greater or lesser weighting for community rewards and other indirect reward points as will later be described. In one illustrative example, the transaction system 102 may offer the following types of package:

| | Price | Redeem | Rebate | Incentive |
|---|---|---|---|---|
| Package | (USD) | Points | Tickets | Points (IP) |
| Starter | 10 | 10 | 10 | 5 |
| Basic | 100 | 100 | 200 | 50 |
| Premium | 1000 | 1000 | 3000 | 500 |

For example, a user who elects to purchase a “Basic” package for $100 will start with 100 Redeem Points and 200 Rebate Tickets. The function of Rebate Tickets in the transaction system 102 will be explained further below.

In other embodiments, no package purchase is required at sign-up in order to receive Reward Points. Instead, users may earn Rebate Points and Referral Points (“Reward Points”) through direct purchases, and/or purchases made by other users that have been directly referred by said users. Subsequently, the said Reward Points of the said user can be used to upgrade the user's status in transaction system 102 (if they choose to), from Starter onwards.

As is apparent from the above, users may register an account in the transaction system 102 at no cost. However, these free users may benefit by receiving reward points from the purchase of subscription packages by other users referred by the free users.

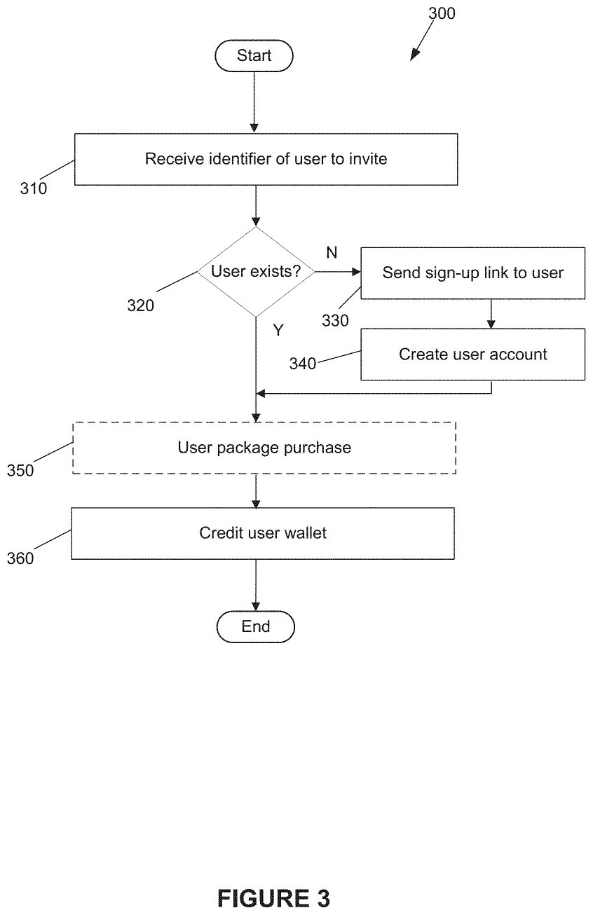

An embodiment of a user referral process 300 is shown in FIG. 3.

At step 310, the transaction system 102 receives, from an existing subscriber user such as subscriber user 210, an identifier of a user to invite as a further subscriber 220. The identifier may be a username, or other identifier such as an email address or mobile phone number.

At step 320, the transaction system 102 checks whether a user corresponding to the received identifier exists. The transaction system 102 may search for the user identifier, or for a record that is linked to the user identifier, in user database 916, for example.

If a user identifier exists in the database 916, the transaction system 102 will allow the corresponding user to proceed straight to a user package purchase step 350 (for which see below).

At step 350, transaction system 102 may prompt the newly added subscriber user 220 to purchase a package, such as the Starter, Basic or Premium packages set out in the table above, to complete account creation. Step 350 is optional; in some embodiments, process 300 may proceed straight to step 360.

At step 360, after new affiliate 220 purchases a package at 350, the Redeem Points and Rebate Tickets balances in the Reward Passport of new affiliate 220 are incremented accordingly. In embodiments where no package purchase takes place, the user's Reward Passport may be credited in a different manner. For example, the user may receive a rebate on a purchase of items at unattended commerce device 160, and/or a rebate on a purchase made by further subscribers which are referred by the user 220. The user may accumulate Reward Points until they have enough Reward Points to upgrade to another level between Starter User and VIP User.

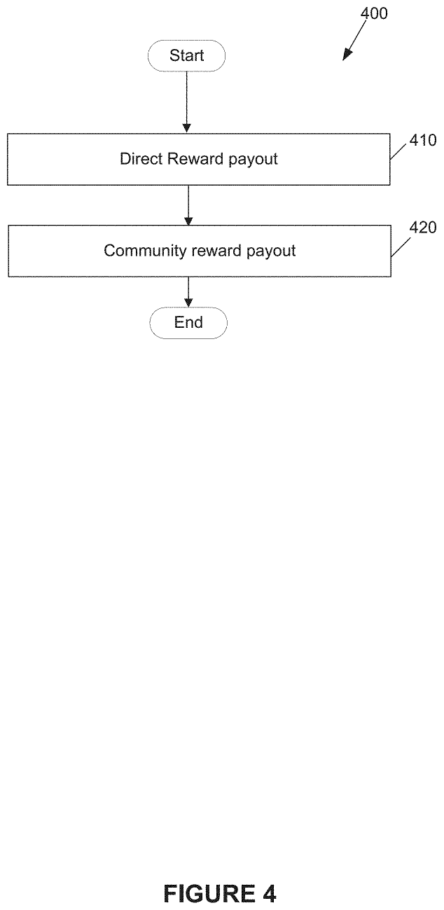

Referring now to FIGS. 4 to 6, embodiments of a computer-implemented method 400 of rewarding Reward Points to computer network users will be described. The method 400 is performed periodically. Some parts of method 400 may be performed with different periodicity than other parts.

The method 400 comprises a first, direct, payout phase (step 410) that comprises, for each user, determining a first Reward Points amount that is dependent on network activity that is directly attributable to the user. The method 400 also comprises a second, indirect, payout phase (step 420) that comprises determining a second Reward Points amount that is at least partly dependent on network activity that is attributable to other users that are below said user in the referral hierarchy.

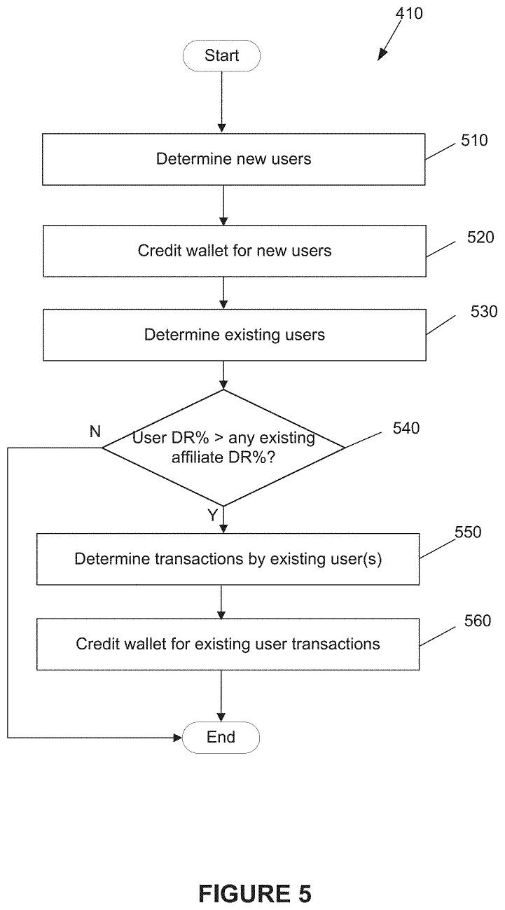

For example, in a first process 410 as shown in FIG. 5 in further detail, a direct reward (DR) payout may be performed on a daily basis.

At step 510, the transaction system 102 determines, for a subscriber user 210, any new subscriber users that have been referred by subscriber user 210 during the reward points distribution period (e.g., within end of the day). For example, referring again to FIG. 2, sub-subscriber user 220 may be an existing sub-subscriber user of subscriber user 210, while sub-subscriber user 222 may be a new subscriber.

At step 520, the transaction system 102 determines network activity that is directly attributable to user 210. This may comprise the referral of sub-subscriber user 222.

In some embodiments, the award of Referral Points may be weighted according to a status of user 210 and/or a status of new sub-subscriber user 222.

For example, user 210 may have a Direct Reward (DR) status that depends on a total value of his personal package purchases and package purchases of users that he has referred. One example of a method of calculating DR status is shown in the tables below, in which the abbreviation “PV” stands for Promotion Value. A user's with DR status (also referred to as DR percentage or DR % herein) depends on their accumulated PV. Accumulated PV or APV is determined by adding the user's Redeem Points to their Referral Points. In one specific example, if a user 210 has purchased a basic package (thus obtaining 100 Redeem Points), and refers two users, a first user 220 of whom purchases a premium package and a second user 222 of whom purchases a basic package, the Referral Points awarded to user 210 would be 50+5=55, thus resulting in an APV of 100+55=155. User 210 would therefore remain in the Basic tier and have a DR % of 10%. If user 210 referred twenty further users who purchased Premium packages, the additional Referral Points (10% of 500×20) would result in an incremented accumulated PV of 1,155, meaning that the user 210 could upgrade to the Premium tier, and the DR % of user 210 would increase to 20%.

| | | |
|---|---|---|
| Membership | (APV = Redeem Points + | |
| Type | Referral Points) | DRI % |

| | | | |
|---|---|---|---|
| Free User | 0-9 | APV | 10% |
| Starter | 10-99 | APV | 10% |
| Basic | 100-999 | APV | 10% |
| Premium | 1,000-9,999 | APV | 20% |

| | | |
|---|---|---|
| VIP | 10,000 APV Onwards | 30% |

Assuming that the DR status of user 210 was a DR % of 10%, then referral of a user (sub-subscriber user) 220 who purchased a premium package would result in an award of Referral Points of 10% of 500IP, i.e. 50 Referral Points.

Still on step 520, the total of the first reward amount is the referral award (e.g., 10% of the IP value for packages purchased by referred users) plus the purchase award (e.g., 100% of the purchase value in dollars).

Optionally, transaction system 102 may determine an additional indirect payout amount to user 210 that is an overriding commission on sales made by direct sub-subscriber 220, 222. To do so, transaction system 102 first determines, at step 530, whether there is any DR percentage difference between subscriber user 210 and their sub-subscribers 220 or 222. If so, then at step 540, transaction system 102 determines whether the DR status of user 210 is higher than the DR status of any sub-subscribers 220, 222. If not, the process 410 ends. Otherwise, for each sub-subscriber users 220, 222 for which the DR status is exceeded by user 210, the transaction system 102 determines, at step 550, the total value (in IP) of sales or purchases (collectively, transactions) made by the sub-subscribers 220, 222. The additional direct payout amount is then computed as ΔDR×IP_{sub}, where ΔDR is the difference in DR % and IP_{sub} is the total IP value of transactions by sub-subscribers 220, 222.

At step 560, the additional indirect payout amount is credited to the Referral Points balance in the Reward Passport of user 210.

As mentioned above, user 210 may also receive a second Reward amount that is at least partly dependent on Community activity that is attributable to other users 220, 222 (and their sub-subscribers, and so on) that are below user 210 in the community hierarchy. One example of such a second Reward Points amount is termed a “community reward” herein, and an exemplary method of determining the community reward will now be described.

In at least some embodiments, the transaction system 102 may set a “burn-in” period before which community rewards are not distributable. Until the burn-in period expires, transaction system 102 continues to perform direct payout process 410 on a regular (e.g. daily) basis, but does not consider any indirect awards that may be payable to subscribers 120. In one example, the burn-in period may be 30 days.

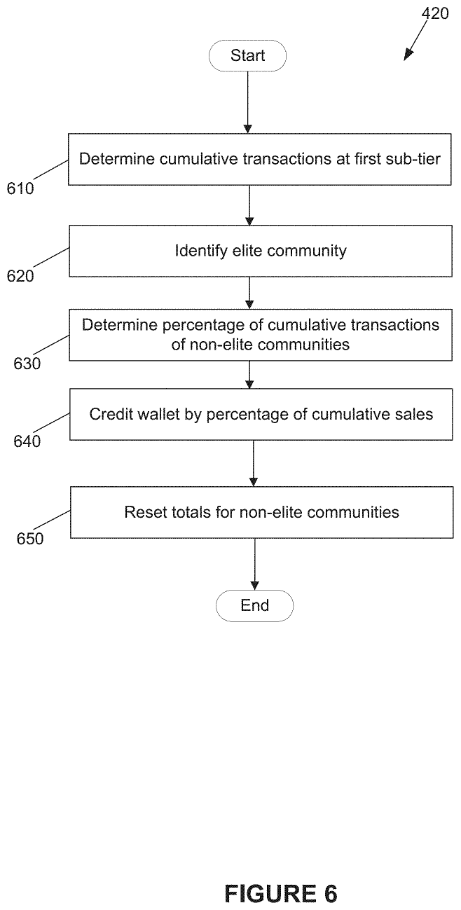

Once the burn-in period expires, and with reference to FIG. 6, a first indirect reward points payout in the form of a community reward process 420 may be conducted as follows.

In a first step 610, the transaction system 102 determines, for a given user 210, the cumulative transactions at the first tier below user 210. Thus, for example, with reference to FIG. 2, the transaction system 102 begins at the tier below user 210, and for each sub-subscriber user in that tier, traverses downwards through the tree 200, keeping a running total of the IP value of transactions as it does so. For example, assuming that Tier 4 is the lowest level of tree 200, the total IP value at Tier 2 for sub-affiliate 220 would be the total for Tier 3 (subscribers 230 and 232), plus the total for Tier 4 (subscribers 240 and 242), plus the total for sub-affiliate 220 itself.

Each sub-tree of the tree 200 starting at user 210 is termed a “community” of user 210. That is, in the example of FIG. 2, user 210 has two communities—the community consisting of the sub-tree rooted at user 220, and the community consisting of the sub-tree rooted at user 222. A total IP value can be determined for each such community, as described in the preceding paragraph.

At step 620, the transaction system 102 determines an “elite community”. This is the community which has the highest total IP value after the burn-in period. For example, if the community rooted at sub-affiliate 220 has a total IP value of 50,000 IP, and the community rooted at sub-affiliate 222 has a total IP value of 35,000 IP, then the sub-affiliate 220 community is the elite community.

At step 630, the transaction system 102 determines an indirect Reward Points amount that is dependent on the total IP value of the non-elite communities. The indirect Reward Points amount may be a fixed percentage (community reward percentage or CR %) of the total IP value of the non-elite communities, such as 10%. In the example of the preceding paragraph, the non-elite community is the sub-affiliate 222 community, which has a total IP value of 35,000. The indirect Reward Points amount would therefore be 3,500 Rebate Points.

At step 640, the transaction system 102 increments the Rebate Points balance of the Reward Passport of user 210 according to the indirect Reward Points amount computed at step 630.

In some embodiments, the transaction system 102 may cap the indirect Reward Points amount by the use of Rebate Tickets. For example, transaction system 102 may limit the indirect Reward Points payout based on the Rebate Tickets balance of user 210, by requiring that the Rebate Tickets balance be consumed to match the indirect Reward Points amount. If the indirect Reward Points amount exceeds the Rebate Tickets balance, the excess may be added to the Rebate Tickets balance. For example:
Rebate Tickets balance is 2,500;
Indirect Reward Points amount (community reward) is 3,500;
Rebate Tickets balance is completely consumed and user's Rebate Points balance is incremented by 2,500;
Excess of 1,000 Rebate Points is credited as Rebate Tickets, so Rebate Tickets balance is now 1,000.

Advantageously, the use of Rebate Tickets in this way ensures that the total payout in the system 100 is capped at some level below 100%. The cap can be controlled by adjusting the community reward percentage, or the rate at which Rebate Tickets are consumed, for example.

At step 650, transaction system 102 may “reset” the totals for the non-elite communities. That is, in the next payout cycle, any previously accumulated total IP values for the communities are ignored, and only new activity from the current payout cycle is taken into account.

Although the Reward Points from the community reward payout 420 are referred to as “indirect Reward Points”, it should be noted that the network activity of sub-subscribers that gives rise to such Reward Points is restricted to transactions (such as package purchases) made by sub-subscribers that thereby result in the sub-subscribers earning IP. Network activity consisting only of referrals (and thus merely of addition of new users to the network) cannot, in the payout process 400, result in any Reward Points to users higher in the hierarchy.

In the payout process 400 of FIG. 4, and (in at least some embodiments) once the burn-in period expires, DR payout 410 and community reward payout 420 may be performed on a daily basis.

In some embodiments, users may be incentivised for transactions made at e-commerce device 110 or unattended commerce devices 160 that are registered with transaction server 102.

An exemplary unattended commerce device 160 is shown in FIG. 9. The unattended commerce device 160 comprises a conventional vending machine control unit 1010. This control unit 1010 controls vending and other functions of the vending machine, and is connected to the normal vending machine interface and conventional payment systems such as a coin acceptor and even a conventional card acceptor (payment interfaces 1022). However, the control unit 1010 can also accept instructions and communicate through a multidrop bus (MDB) interface 1025 with other components, such as one or more communication interfaces 1020, one or more special purpose payment interfaces 1022 (e.g., NFC-based interfaces that enable contactless payment using smartphones and the like), and one or more processors 1024 that are in communication with memory 1030.

The one or more communication interfaces 1020 enable the unattended commerce device 160 to communicate with external computing systems, such as with transaction system 102 over the internet 20. Accordingly, data generated at the unattended commerce device 160 (for example, regarding completed transactions) may be transmitted to the transaction system 102. Likewise, transaction system 102 may transmit data to the unattended commerce device 160 via the interface(s) 1020.

Unattended commerce device 160 comprises a user interface 1012. The user interface may comprise a display that conveys information to a user about available products, selections of products made by the user, and prompts to the user to perform certain actions, such as launching a payment application on their mobile device or tapping their mobile device to complete confirmation of a transaction. The user interface 1012 may also comprise input means for the user to input product selections (for example). The input means may be the display itself, for example, or a separate component such as a keypad.

Unattended commerce device 160 further comprises a memory 1030 that may store programs and data for controlling various operations of the self-service machine 160. For example, the memory 1030 may store a payment module 1032 that receives requests made by users via user interface 1012, and cooperates with payment interface(s) 1022, and/or communication interface(s) 1020, and control unit 1010 to fulfil service requests (such as requests to vend products from self-service machine 160) in a manner which will be described in further detail below. Memory 1030 may also comprise a rewards module 1034 that computes a reward (e.g. a points reward) to be allocated to a digital wallet of the user.

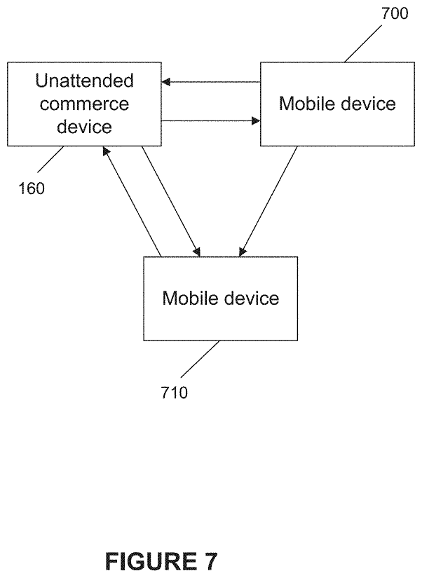

For example, referring to FIG. 7, a user (who may be a subscriber 120 or a free user 130) may initiate a transaction at an unattended commerce device 160, for example a vending machine, for an item such as a cup of coffee. The transaction may be initiated by the user making a selection via the user interface 1012.

Once the selection is made, the user may pair a mobile device 700 with the vending machine 160 to continue the transaction. For example, the vending machine 160 may broadcast an identifier by a wireless communication channel such as WiFi or Bluetooth, such as via communication interface(s) 1020, and the mobile device 700 may discover and connect to the vending machine 160 over the wireless communication channel, and receive, from the vending machine 160, transaction-related information comprising a machine identifier, a user identifier, a transaction amount, and a transaction identifier. In another example, the vending machine 160 may display (for example, in response to a user initiating a request for an item at the vending machine 160), on user interface 1012, a dynamic QR code or other machine-readable code that encodes the transaction-related information.

Once pairing has occurred, the user may be prompted, via a display of mobile device 700, to complete a transaction via a digital wallet application (also referred to herein as a “Reward Passport” application) executing on mobile device 700. If the user is already a subscriber user 120 registered with transaction system 102, they may be prompted to complete the transaction with a digital wallet application that is configured to connect to transaction system 102. If the user is not a registered user 130, they may be prompted to sign up with transaction system 102 in order to receive a rebate or other incentive for the purchase.

The digital wallet application may receive the transaction-related information and form a transaction request message that is transmitted to transaction system 102 for processing. On successful processing, the digital wallet application may receive an authorisation token from transaction system 102. The authorisation token 102 may be transmitted from the transaction system 102 to the vending machine 160 via communications interface(s) 1020. The authorisation token may be received by the payment module 1032, such that instructions may then be sent by processor(s) 1024 to the control unit 1010 to cause vending of the selected product. Confirmation of completion of the transaction may be transmitted back to transaction system 102, which may in turn transmit confirmation to the mobile device 700.

In some embodiments, a reward or rebate may be provided to the user 120. For example, on completion of the transaction, rewards module 1034 may compute a rebate amount or reward points amount, which may be based on the amount of the transaction. Processor 1024 may then cause transmission of the rebate or reward points determined by the rewards module 1034 to the transaction system 102, which may credit the user's 120 digital wallet accordingly (via wallet management module 960, for example—FIG. 8).

In some embodiments, a subscriber user 120 of mobile device 700 may send a referral link to a free user 130 of mobile device 710, as shown in FIG. 7. The referral link may comprise information identifying user 120. Accordingly, when user 130 of mobile device 710 initiates a purchase at vending machine 160 in a manner substantially as described above, user 130 may complete a sign-up process to be registered with transaction system 102, and to have a wallet account created thereby (by wallet management module 960). When the transaction is completed, user 130 may receive Rebate Points.

In some embodiments, the direct reward points and/or indirect reward points may be awarded immediately on completion of a transaction. In other embodiments, they may be awarded periodically, for example during periodic direct reward (DR) payout 410 and/or indirect reward (DR) payout 420 of FIG. 4.

An exemplary architecture of a transaction system 102 is shown in FIG. 8. In the example shown in FIG. 9, the transaction system 102 may comprise a computing device such as a commercially available server computer system based on a 32 bit or a 64 bit Intel architecture, and the processes and/or methods executed or performed by the computing device 102 are implemented in the form of programming instructions of one or more software components or modules 940 stored on non-volatile (e.g., hard disk) computer-readable storage 924 associated with the computing device 102. At least parts of the software modules 940 could alternatively be implemented as one or more dedicated hardware components, such as application-specific integrated circuits (ASICs) and/or field programmable gate arrays (FPGAs).

The computing device 102 comprises at least one or more of the following standard, commercially available, computer components, all interconnected by a bus: random access memory (RAM) 926; at least one computer processor 928; and a network interface connector (NIC) 930 which connects the computer device 102 to a data communications network (such as network 20) and/or to external devices.

The computing device 102 may comprise a plurality of standard software modules, comprising:
an operating system (OS) (e.g., Linux or Microsoft Windows);
web server software such as Apache, available at http://www.apache.org;
scripting language support such as PHP, available at http://www.php.net, or Microsoft ASP; and
structured query language (SQL) modules (e.g., MySQL, available from http://www.mysql.com), which allow data to be stored in and retrieved/accessed from an SQL database such as user database 916 and merchant database 918.

Together, the web server, scripting language module, and SQL module provide the transaction system 102 with the general ability to allow users of the Internet 20 with standard computing devices equipped with standard web browser software to access the transaction system 102 and in particular to provide data to and receive data from the databases 916 and 918.

However, it will be understood by those skilled in the art that the specific functionality provided by the transaction system 102 to such users is provided by scripts accessible by the web server, comprising the one or more software modules 940 implementing process 400 and its sub-processes, and also any other supporting scripts and data (not shown), comprising markup language (e.g., HTML, XML) scripts, PHP (or ASP), and/or CGI scripts, image files, style sheets, and the like.

Advantageously, the database 916 forms part of the computer readable data storage 924. Alternatively, the database 916 is located remote from the server 102 shown in FIG. 8.

The boundaries between the modules and components in the software modules 940 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of those parts of the process 400 performed by the transaction system 102 may be executed by a module (of software modules 940) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

For example, as shown in FIG. 8, the modules 940 may comprise:
a user management module 942 that manages sign-up and maintenance of users 110, 120, 130;
a Reward Points distribution 950 that causes execution of the process 400;
a direct rewards (DR) module 952 that causes execution of the sub-process 410;
a community reward (CR) module 954 that causes execution of the sub-process 420;
a wallet management module 960 that enables users to add value to their reward passport, or transact with other users of the transaction system 102, comprising merchant users 110; and
an e-commerce module 970 that enables merchant users 110 to list goods or services for sale at the transaction system 102 and to receive payment for them from subscriber users 120 or free users 130.

The computing device 102 normally processes information according to a program (a list of internally stored instructions such as a particular application program and/or an operating system) and produces resultant output information via input/output (I/O) devices 930. A computer process typically comprises an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A computer-implemented method of distributing reward points to computer network users in a transaction system, said users being arranged in a hierarchy, the method comprising:
periodically, by at least one processor, performing a payout process for each user comprising:
determining a direct reward points amount that is dependent on network activity that is directly attributable to the user;
determining an indirect reward points amount that is at least partly dependent on network activity that is attributable to other users that are below said user in the hierarchy; and
crediting a digital wallet of the user by the direct reward points amount and the indirect reward points amount;
wherein said network activity comprises one or more electronic transactions conducted via the transaction system, and/or addition of one or more users to the transaction system.

2. A computer-implemented method according to claim 1, wherein the one or more electronic transactions comprise e-commerce transactions.

3. A computer-implemented method according to claim 1, wherein the direct reward points amount is one or more of a rebate, or an increment to a loyalty balance.

4. A computer-implemented method according to claim 1, wherein the indirect incentive amount is one or more of a rebate, or an increment to a loyalty balance.

5. A computer-implemented method according to claim 1, wherein the indirect reward points amount is capped according to a points balance of the user.

6. A computer-implemented method according to claim 1, further comprising, by the at least one processor, crediting a digital wallet of the user by an additional direct reward points amount and/or an additional indirect reward points amount based on purchase transactions made by the user and/or the other users that are below said user in the hierarchy.

7. A computer-implemented method according to claim 6, wherein the crediting of the additional direct reward points amount and/or the additional indirect reward points amount occurs during the payout process.

8. A transaction system comprising at least one processor and computer-readable storage having stored thereon instructions for causing the at least one processor to perform, for a hierarchy of network users, a reward points distribution process comprising:
periodically, by the at least one processor, performing a payout process for each user comprising:
determining a direct reward points amount that is dependent on network activity that is directly attributable to the user;
determining an indirect reward points amount that is at least partly dependent on network activity that is attributable to other users that are below said user in the hierarchy; and
crediting a digital wallet of the user by the direct reward points amount and the indirect reward points amount;
wherein said network activity comprises one or more electronic transactions conducted via the transaction system, and/or addition of one or more users to the transaction system.

9. A system comprising:
a transaction system; and
at least one unattended commerce device in communication with the transaction system;
wherein the unattended commerce device is configured to receive, from a user and/or the transaction system, an authorisation token indicative of completion of payment for a product vendible by the unattended commerce device, and responsive thereto, to vend the product; and
wherein the transaction system is configured to:
receive, from the unattended commerce device, transaction data comprising a transaction completion indicator; and
update network activity data for the user based on the transaction data, the network activity data being based on an amount of the payment and/or a type of the product.

10. A system according to claim 9, wherein the transaction data further comprises a reward or rebate amount determined by the unattended commerce device, and wherein the transaction system is configured to credit a digital wallet of the user based on the reward or rebate amount.

11. A system according to claim 9, wherein the user is one of a hierarchy of users of the transaction system, and wherein the transaction system is configured to perform a reward points distribution process comprising:
periodically performing a payout process for the user comprising:
obtaining the network activity data of the user;
determining a direct reward points amount that is dependent on the network activity data;
determining an indirect reward points amount that is at least partly dependent on network activity that is attributable to other users that are below said user in the hierarchy; and
crediting a digital wallet of the user by the direct reward points amount and the indirect reward points amount;
wherein said network activity comprises addition of one or more further users to the transaction system.

12. A system according to claim 11, wherein the direct reward points amount is also dependent on one or more e-commerce transactions.

13. A system according to claim 11, wherein the direct reward points amount is one or more of a rebate, or an increment to a loyalty balance.

14. A system according to claim 11, wherein the indirect incentive amount is one or more of a rebate, or an increment to a loyalty balance.

15. A system according to claim 11, wherein the indirect reward points amount is capped according to a points balance of the user.

16. A system according to claim 11, wherein the reward points distribution process further comprises crediting a digital wallet of the user by an additional direct reward points amount and/or an additional indirect reward points amount based on purchase transactions made by the user and/or the other users that are below said user in the hierarchy.

17. A system according to claim 16, wherein the crediting of the additional direct reward points amount and/or the additional indirect reward points amount occurs during the payout process.
